(19) United States
(12) Patent Application Publication
(10) Pub. No.: US 2015/0239153 A1
(43) Pub. Date: Aug. 27, 2015

(54) USE OF PELLETS

(71) Applicants: Gerard Jan Eduard BIEMOND, (US); Carmela TUFANO, (US); Saudi Basic Industries Corporation, Riyadh (SA)

(72) Inventors: Gerard Jan Eduard Biemond, Geleen (NL); Carmela Tufano, Geleen (NL)

(21) Appl. No.: 14/429,825

(22) PCT Filed: Sep. 24, 2013
(86) PCT No.: PCT/EP2013/069786

§ 371 Date: Mar. 20, 2015

(30) Foreign Application Priority Data
Sep. 25, 2012 (EP) 12006702.0

(51) Int. Cl. B29B 9/14; C09D 123/14; B29B 15/14; C09D 123/12

(52) U.S. Cl. CPC B29B 9/14; C09D 123/12; C09D 123/14; B29B 15/14; B29K 2023/12

(57) ABSTRACT

The present invention relates to the use of pellets having a length of at least 13 mm and comprising a thermoplastic polymer sheath intimately surrounding glass filaments, which glass filaments are covered at least in part with an impregnating agent and extend in a longitudinal direction of said pellets, for reducing the amount of glass filaments separating from the pellets when such pellets are subjected to repetitive mechanical loads.

The present invention relates to the use of pellets having a length of at least 13 mm and comprising a thermoplastic polymer sheath intimately surrounding glass filaments, which glass filaments are covered at least in part with an impregnating agent and extend in a longitudinal direction of said pellets.

The present invention further relates to a method for reducing an amount of glass filaments separating from pellets comprising a thermoplastic polymer sheath intimately surrounding the glass filaments, which glass filaments are covered at least in part with an impregnating agent and extend in a longitudinal direction of said pellets, when such pellets are subjected to repetitive mechanical loads.

In general the present invention lies in the technical field of long glass filament reinforced thermoplastic polymers.

Pellets comprising a thermoplastic polymer sheath intimately surrounding glass filaments, which glass filaments are covered at least in part with an impregnating agent and extend in a longitudinal direction of said pellets, are commercially available from SABIC Innovative Plastics, an affiliate of Saudi Basic Industries Corporation, under the brand name Stamax.

A process for manufacturing such pellets is known from WO 2009080281, which process comprises the subsequent steps of:
a) unwinding from a package of at least one continuous glass multifilament strand containing at most 2% by mass of a sizing composition;
b) applying from 0.5 to 20% by mass of an impregnating agent to said at least one continuous glass multifilament strand to form an impregnated continuous multifilament strand;
c) applying a sheath of thermoplastic polymer around the impregnated continuous multifilament strand to form a sheathed continuous multifilament strand;
characterised in that the impregnating agent is non-volatile, has a melting point of at least 20° C. below the melting point of the thermoplastic matrix, has a viscosity of from 2.5 to 100 cS at application temperature, and is compatible with the thermoplastic polymer to be reinforced.

According to WO 2009080281 the sheathed continuous glass multifilament strand may be cut into pellets having a length of from 2 to 50 mm, preferably from 5 to 30 mm, more preferably from 6 to 20 mm and most preferably from 10 to 15 mm.

The pellets may be used for producing articles by suitable moulding techniques, such as injection moulding, compression moulding, extrusion and extrusion compression moulding. Injection moulding is widely used to produce articles such as automotive exterior parts like bumpers, automotive interior parts like instrument panels, or automotive parts under the bonnet.

The skilled person will appreciate that the glass filaments in the type of pellets produced in accordance with WO2009080281 are not yet dispersed in the thermoplastic polymer of the sheath. The present inventors have found that this may result in glass filaments separating from the pellets when such pellets are subjected to repetitive mechanical loads. Such repetitive mechanical loads may occur during transport of the pellets through a piping system, or a vibrating conveyor means, such as a vibrating conveyor belt. Further repetitive mechanical loads occur when a number of pellets are shaken, stirred or when a number of pellets is filled into a suitable transport container, such as for example an octabin. In addition to that the transport container may be subject to vibrations during transport which may also be a cause of glass filaments separating from the pellet. It should be understood that several variations of the above examples may also be considered as repetitive mechanical loads. The repetitive mechanical loads are usually random in nature.

Of particular importance is the separation of glass filaments from the pellets during transport of the pellets through a piping system because the separated filaments may cause blocking of the piping system and/or of filters, valves, outlets and the like that are used in the piping system. Such blocking may result in down time of the equipment and possible loss of processing capacity. The present inventors generally refer to this problem as the “free glass” problem.

It is therefore an object of the present invention to provide pellets comprising a thermoplastic polymer sheath intimately surrounding glass filaments, which glass filaments are covered at least in part with an impregnating agent and extend in a longitudinal direction of said pellets, wherein the amount of glass filaments separating from the pellet when the pellet is subjected to repetitive loads is reduced to a minimum.

To that extent the present inventors have found that if the pellets are cut to a length of at least 13 mm the amount of glass filaments separating from the pellets is significantly reduced compared to shorter pellets. Consequently in a first aspect the present invention is directed to the use of pellets having a length of at least 13 mm and comprising a thermoplastic polymer sheath intimately surrounding glass filaments, which glass filaments are covered at least in part with an impregnating agent and extend in a longitudinal direction of said pellets, for reducing the amount of glass filaments separating from the pellets when such pellets are subjected to repetitive mechanical loads.

In an aspect the present invention is directed to the use of pellets having a length of at least 13 mm and comprising a thermoplastic polymer sheath intimately surrounding glass filaments, which glass filaments are covered at least in part with an impregnating agent and extend in a longitudinal direction of said pellets, for reducing the amount of glass filaments separating from the pellets upon transportation of the pellets through a piping system, for example by means of air drag or upon transportation by means of a vibrating conveyor means, such as a conveyor belt.

Without willing to be bound to it the present inventors believe that an increased mechanical coupling between the glass filaments and the thermoplastic polymer sheath that intimately surrounds the filaments results in a reduced amount of free glass, i.e. a reduced amount of fibres that has separated from the pellets.

In accordance with the present invention therefore the object is met.

Preferably the pellet length is from 13-20 mm, preferably from 14-18, more preferably from 15-17 mm. Pellet lengths of over 20 mm may be more difficult to process in an injection moulding equipment and/or would require modification thereof. Longer pellets, such as from 20 mm to 50 mm may be suitable for compression moulding techniques.

The pellets used in accordance with the present invention preferably contain from 10 to 70 wt %, preferably from 20 to 60 wt % of glass filaments based on the weight of the pellets.

The glass filaments in the pellets used in the present invention preferably have a thickness of from 5-50 μm preferably from 10-30 μm, more preferably from 15-25 μm. The glass filaments are generally circular in cross section.

The length of the glass filaments typically corresponds to the length of the pellet. Small differences in length between the pellet and the glass filaments may arise due to post-extrusion shrinkage of the thermoplastic polymer sheath or due to the applied pellet cutting technology. The glass filaments generally lie in parallel to one another. For the avoidance of doubt it should be understood that the glass filaments as used in the present invention are not embedded in the thermoplastic polymer sheath.

U.S. Pat. No. 6,548,167 discloses a continuous fiber granulate comprising of granulate corns in which reinforcing staple fibers are helically arranged in a thermoplastic matrix. The glass filaments in the present invention are not arranged helically, and contrary to the granulate corns of U.S. Pat. No. 6,548,167 have a length corresponding to the length of the pellets. In addition the process for making the granulate corns in this US patent differs significantly from the process for manufacturing the pellets according to the present invention. For example, the thermoplastic polymer sheath in the present invention does not comprise glass filaments; the method of U.S. Pat. No. 5,648,167 does not comprise the subsequent steps of applying an impregnating agent to a multifilament strand and sheathing the multifilament strand with a thermoplastic material.

The glass filaments in the pellets subject to the use of the present invention preferably contain at most 2 wt % of a sizing composition based on the total weight of the glass filaments.

In a further aspect the present invention is directed to a method for reducing an amount of glass filaments separating from pellets comprising a thermoplastic polymer sheath intimately surrounding the glass filaments, which glass filaments are covered at least in part with an impregnating agent and extend in a longitudinal direction of said pellets, when such pellets are subjected to repetitive mechanical loads, the method comprising the subsequent steps of:
a) providing at least one continuous strand of glass filaments containing at most 2 wt % of a sizing composition based on the total weight of the glass filaments, and
b) applying from 0.5 to 20 wt % based on the weight of the glass filaments (including the sizing composition) in the pellets, of an impregnating agent to said strand,
c) applying a sheath of thermoplastic polymer around the strand of step b) to form a sheathed continuous strand of glass filaments covered at least in part with said impregnating agent;
d) cutting the sheathed continuous strand of glass filaments covered at least in part with said impregnating agent to pellets having a length of at least 13 mm.

The thermoplastic polymer sheath is preferably comprised of polyolefins. More preferably the thermoplastic polymer used as a sheath material in the pellet according to the invention is a crystalline polypropylene such as propylene homopolymer, a random copolymer, or a heterophasic copolymer of propylene and ethylene and/or another alpha-olefin. The thermoplastic polymer sheath may further contain one or more of additives like UV stabilisers, anti-oxidants, processing aids, impact-modifiers, flame-retardants, acid scavengers, inorganic fillers, colorants, or components that further enhance the properties of the reinforced compound, like compounds that enhance interfacial bonding between polymer and glass filaments. An example of the last compounds is a functionalized polyolefin, like a maleated polypropylene, in case the thermoplastic polymer is a polypropylene.

Any method known in the art to apply a sheath of thermoplastic polymer around the continuous strand of glass filaments may be used. The sheathing or wire-coating process typically involves the application of a thermoplastic polymer layer on the outer surface of the continuous glass strand as it passes through the thermoplastic polymer melt in a die. Documents EP092191981 and EPP099497881 for example describe a typical sheathing or wire-coating method. According to the present invention, the resulting sheathed continuous strand of glass filaments comprises a core containing the glass filaments that are at least partially covered with an impregnating agent and a sheath intimately surrounding the glass filaments. The term intimately surrounding as used herein is to be understood as meaning that the thermoplastic polymer sheath substantially entirely contacts the core containing the at least partially covered glass filaments. Said in another way the sheath is applied in such a manner that there is no deliberate gap between an inner surface of the sheath and the core containing the fibre filaments. A skilled person will nevertheless understand that a certain small gap between the thermoplastic polymer sheath and the glass filaments may be formed as a result of process variations.

Suitable examples of sizing compositions include solvent-based compositions, such as an organic material dissolved in aqueous solutions or dispersed in water and melt- or radiation cure-based compositions. More particularly, an aqueous sizing composition is traditionally applied on the individual glass filaments. As already described in the art, e.g. in documents EP1460166A1, EP0206189A1 or U.S. Pat. No. 4,338,233, the aqueous sizing composition typically includes film formers, coupling agents and other additional components. The film formers are generally present in effective amount to protect glass filaments from inter-filament abrasion and to provide integrity and processability of glass filament strands after they are dried. Suitable film formers should be miscible with the polymer to be reinforced. For example, for reinforcing polypropylenes, suitable film formers generally comprise polyolefin waxes.

The coupling agents in the sizing composition are generally used to improve the adhesion between the thermoplastic polymer sheath, which in the moulded article will form the thermoplastic polymer matrix and the glass filament reinforcements. Suitable examples of coupling agents known in the art as being used for the glass fibres include organofunctional silanes.

Any other additional components known to the skilled person may be present in the sizing composition. Suitable examples include lubricants, antistatic agents, crosslinking agents, plasticizers, surfactants, nucleation agents, antioxidants, anti-foaming agents, pigments and any combinations thereof.

The continuous strand of glass filaments is usually provided from a bobbin on which it is wound. A continuous strand of glass filaments which contains at most 2 wt % of a sizing composition is employed in the process of present invention. Preferably, a continuous strand of glass filaments containing from 0.1 to 1 wt % of sizing composition. The amount of sizing composition is determined from loss on ignition (LOI) measurement. The measurement of LOI is well-known for determining the amount of sizing on glass filaments. The glass filament density of the continuous strand of glass filaments may vary within wide limits. Preferably, the continuous strand of glass filaments may contain from 500 to 10000 glass filaments per strand, more preferably from 2000 to 5000 glass filaments per strand. The linear density of the strand preferably is from 1000 to 5000 tex, corresponding to 1000 to 5000 grams per 1000 meter. The thickness of the glass filaments preferably is from 5-50 μm, more preferably from 10-30 μm, even more preferably from 15-25 μm. Usually the glass filaments are circular in cross section meaning the thickness as defined above would mean diameter.

The process of the present invention comprises a step of applying of from 0.5 to 20 wt % based on the weight of the glass filaments (including the sizing composition) in the pellets, of an impregnating agent to said at least one continuous strand. Said impregnating agent is non-volatile, has a melting point of at least about 20° C. below the melting point of the thermoplastic polymer sheath and has a viscosity of from 2.5 to 100 cS at application temperature. The impregnating agent is compatible with the thermoplastic polymer sheath meaning that the impregnating agent is miscible with the thermoplastic polymer used for the sheath. In other words, after molding of the pellets the impregnating agent will not form separate phases in the thermoplastic polymer matrix which is based on the thermoplastic polymer sheath. The step of applying the impregnating agent takes place after unwinding the packaged continuous strand of glass filaments containing the sizing composition, and in-line with the step of applying the thermoplastic polymer sheath around the strand of glass multifilaments. “In-line” means that no intermediate steps, such as for example storage or cooling, are performed between the step of applying the impregnating agent and the step of applying the thermoplastic polymer sheath. In practice both steps may be performed directly after each other, meaning for example that the impregnating agent still has relatively high temperature, hence a low viscosity.

The impregnating agent used in the present invention has at least two functions. Firstly it mechanically couples the glass filaments, at least in part, to each other and to the thermoplastic polymer of the thermoplastic sheath. This function is important in view of reducing the amount of glass filaments separating from the pellets when such pellets are subjected to repetitive mechanical. Secondly the impregnating agent is a compound that enhances the dispersion of the glass filaments in the thermoplastic polymer matrix during a moulding process wherein pellets are moulded into articles in which articles the glass filaments are distributed in the thermoplastic matrix of the article in a substantially uniform manner.

The viscosity of the impregnating agent should be lower than 100 cS, preferably lower than 75 cS and more preferably lower than 25 cS at application temperature. The viscosity of the impregnating agent should be higher than 2.5 cS, preferably higher than 5 cS, and more preferably higher than 7 cS at the application temperature. An impregnating agent having a viscosity higher than 100 cS is difficult to apply to the continuous strand of glass filaments. Low viscosity is needed to facilitate good wetting performance of the fibres, but an impregnating agent having a viscosity lower than 2.5 cS is difficult to handle, e.g., the amount to be applied may be more difficult to control. The melting point of the impregnating agent is at least about 20° C., preferably at least 25° C. or at least 30° C. below the melting point of the thermoplastic polymer of the thermoplastic polymer sheath. The application temperature of the impregnating agent is selected such that the desired viscosity range is obtained. The amount of impregnating agent that is applied depends on the thermoplastic polymer for the sheath, on the size (diameter) of the glass filaments of the continuous strand, and on the type of sizing that is on the surface of the glass filaments. According to the present invention, the amount of impregnating agent applied to the continuous strand of glass filaments should be higher than 0.5 wt %, preferably higher than 2 wt %, more preferably higher than 4 wt %, more preferably higher than 6 wt % based on the weight of the glass filaments (including the sizing composition) in the pellets. The amount of impregnating agent should be lower than 20 wt % preferably lower than 18 wt %, more preferably lower than 15 wt % more preferably lower than 12 wt %. A certain minimum amount of impregnating agent is needed to assist homogeneous dispersion of glass filaments in the thermoplastic polymer matrix during moulding. An excess of impregnating agent may result in decrease of mechanical properties of the moulded articles. Suitable examples of impregnating agents for use in combination with polypropylene as the material for the sheath may comprise highly branched poly(alpha-olefins), such as polyethylene waxes, modified low molecular weight polypropylenes, mineral oils, such as, paraffin or silicon and any mixtures of these compounds. Preferably, the impregnating agent comprises a highly branched poly(alpha-olefin) and, more preferably, the impregnating agent is a highly branched polyethylene wax. The wax may optionally be mixed with a hydrocarbon oil or wax like a paraffin oil to reach the desired viscosity. According to the present invention the impregnating agent is non-volatile, and substantially solvent-free. Non-volatile means that the impregnating agent does not evaporate under the application and processing conditions applied. In the context of present invention, “substantially solvent-free” means that the impregnating agent contains less than 10% by mass of solvent, preferably less than 5% by mass solvent. Most preferably, the impregnating agent does not contain any organic solvent. The impregnating agent may further be mixed with other additives known in the art such as lubricants, antistatic agents, UV stabilizers, plasticizers, surfactants, nucleation agents, antioxidants, pigments, dyes, adhesion promoters, such as a modified polypropylene having maleated, provided the viscosity remains within the desired range.

Any method known in the art may be used for applying the liquid impregnating agent to the continuous strand of glass filaments. Suitable methods for applying the impregnating agent include applicators having belts, rollers, and hot melt applicators. Such methods are for example described in documents EP0921919, EP0994978B 1, EP0397505B1 and references cited therein.

The present invention will now be further explained by the following examples which should not be considered as limiting the present invention in any way.

### EXAMPLES 1-5

A sheathed continuous strand of glass filaments, which glass filaments are covered at least in part with an impregnating agent was manufactured in accordance with the method of WO 2009080281 on a pilot line.

The continuous strand of glass filaments had a linear density of 3000 Tex and comprised 0.35 wt % of a sizing composition. The glass filaments had an average diameter of 19 μm. The strand was provided with 8.7 wt % of an impregnating agent as defined in WO 2009080281 having a drop melting point of 77° C. (ASTM D127) and a viscosity at 100° C. of 50 mPa·s. Following the application of the impregnating agent a propylene homopolymer sheath comprising SABIC PP 579 S, having an MFI of 47 g/10 min (ISO 11330, 2.16 kg @ 230° C.) was provided around the continuous strand of glass filaments in such a manner that the propylene homopolymer intimately surrounded the continuous strand. The sheathed strand was cooled in a water bath after which it was cut into pellets having a length as indicated in Table 1 below. The pellets comprised 30 wt % of glass filaments.

The tendency for glass filaments separating the pellets was measured using two different methods.

The first method actually measures the amount of glass filaments separating from the pellets. To that extent 1 kg of pellets is fed to a first container and then, by means of air drag, transported to a second container through a (curved) flexible pipe of about 2.5 m long. The air is filtered through a device filter with sufficient pore size to capture any glass filament separating from the pellets. The pellets are then transported to the first container again and the procedure is repeated for four additional times. The weight of the device filter is measured before and after the test so that it can be established how much glass filaments have separated from the kilo of pellets. In an alternative manner the device filter is vacuum cleaned and the amount of glass filaments is separated and weighed. Both methods yield the same results.

The second method involves the manual testing of 100 pellets randomly selected from a batch of pellets. An operator uses a needle having a blunt tip with a surface area slightly smaller than the surface area of the core of the pellet, i.e. the surface area occupied by the glass filaments. The operator then tries to push out the glass filaments using this needle. The amount of successful push outs per 100 pellets is reported. Although this method is more subjective than the first method, for reason that the outcome of the test may depend on the force that the operator uses when trying to push out the glass filaments, it can also be used to show the effect of the present invention.

Table 1 below shows the normalized results of both tests. Example 1 is regarded as the reference example and is not according to the present invention.

The table clearly shows that the “free glass” reduces significantly when the pellet length is increased from 12.1 to 17.9. The same advantageous effect is observed for the “push out”.

TABLE 1

| | Pellet length | Free glass | Push out |
|---|---|---|---|
| | [mm] | [−] | [−] |
| Ex. 1 | 12.1 | 1 | 1 |
| Ex. 2 | 13.7 | 0.71 | 0.61 |
| Ex. 3 | 14.6 | 0.34 | 0.46 |
| Ex. 4 | 16.4 | 0.17 | 0.36 |
| Ex. 5 | 17.9 | 0.12 | 0.25 |

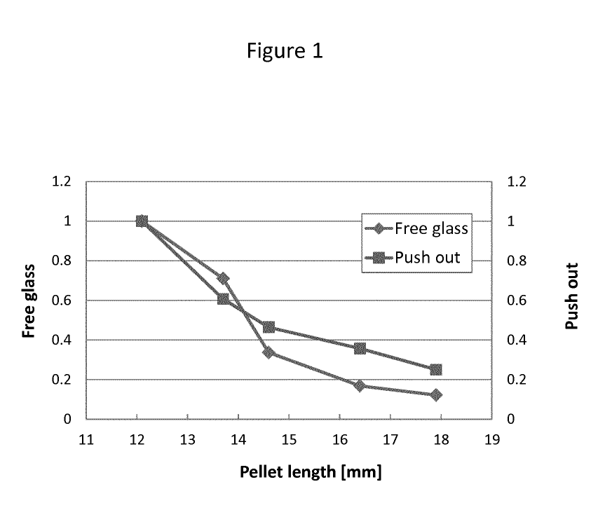

FIG. 1 shows the same results, i.e. the normalized values of “free glass” and “push out”, in a graph are plotted against the pellet length. The FIGURE clearly shows that the tendency for glass filaments separating from the pellets is significantly reduced compared to Example 1 when the pellet length is increased to at least 13 mm. The graph shows that there is a significant improvement of the free glass in the range of 12 to about 14 mm pellet length.

### EXAMPLES 6-7

A sheathed continuous strand of glass filaments, which glass filaments are covered at least in part with an impregnating agent was manufactured in accordance with the method of WO 2009080281 on a production line.

The continuous strand of glass filaments had a linear density of 3000 Tex and comprised 0.6 wt % of a sizing composition. The strand was provided with 8 wt % of impregnating agent. The impregnating agent for Examples 6-7 was the same as the impregnating agent in Examples 1-5.

Following the application of the impregnating agent a propylene sheath was provided around the continuous strand of glass filaments in such a manner that the propylene polymer intimately surrounded the continuous strand. The sheathed strand was cooled in a water bath after which it was cut into pellets having a length as indicated in Table 2 below. The pellets comprised 60 wt % of glass filaments.

Table 2 below shows the normalized results of both tests. The examples with pellet length of 12.5 mm were regarded as the reference example.

It is clear that the “free glass” reduces significantly when the pellet length is increased from 12.5 to 15. The same advantageous effect is observed for the “push out”.

TABLE 2

| | | Pellet length | Free glass | Push out |
|---|---|---|---|---|
| | Polypropylene | [mm] | [−] | [−] |
| Ex. 6 | PP homopolymer | 12.5 | 1 | 1 |
| | SABIC PP 579 S | 15 | 0.59 | 0.60 |
| | MFI = 47 g/10 min (ISO 1133, | | | |
| | 2.16 kg @ 230° C.) | | | |
| Ex. 7 | PP copolymer | 12.5 | 1 | 1 |
| | SABIC PP 513 MNK 10 | 15 | 0.70 | 0.50 |
| | MFI = 70 g/10 min | | | |
| | (ISO 1133, 2.16 kg @ 230° C.) | | | |

What is claimed is:

1. Pellets having a length of at least 13 mm and comprising a thermoplastic polymer sheath intimately surrounding glass filaments, which glass filaments are covered at least in part with an impregnating agent and extend in a longitudinal direction of said pellets, and which reduces the amount of glass filaments separating from the pellets when such pellets are subjected to repetitive mechanical loads.

2. The pellets according to claim 1 wherein the repetitive mechanical loads comprise vibration of the pellets.

3. The pellets according to claim 2 wherein the repetitive mechanical loads comprise shaking of the pellets.

4. The pellets according to claim 1 wherein the pellets have a length of from 13-20 mm.

5. The pellets according to one or more of claim 1 wherein the pellets contain from 10 to 70 wt % of glass filaments based on the weight of the pellets.

6. The pellets according to claim 1 wherein the glass filaments have a thickness of from 5-50 μm.

7. A method for reducing an amount of glass filaments separating from pellets comprising a thermoplastic polymer sheath intimately surrounding the glass filaments, which glass filaments are covered at least in part with an impregnating agent and extend in a longitudinal direction of said pellets, when such pellets are subjected to repetitive mechanical loads, the method comprising:
a) providing at least one continuous strand of glass filaments containing at most 2 wt % of a sizing composition based on the total weight of the glass filaments, and
b) applying from 0.5 to 20 wt %, based on the weight of the glass filaments in the pellets, of an impregnating agent to said strand,
c) applying a sheath of thermoplastic polymer around the strand of step b) to form a sheathed continuous strand of glass filaments covered at least in part with said impregnating agent; and
d) cutting the sheathed continuous strand of glass filaments covered at least in part with said impregnating agent to pellets having a length of at least 13 mm.

8. The method according to claim 7 wherein the impregnating agent is non-volatile, has a melting point of at least 20° C. below the melting point of the thermoplastic polymer sheath, has a viscosity of from 2.5 to 100 cS at application temperature, and is compatible with the thermoplastic polymer.

9. The method according to claim 7 wherein the pellets are cut to a length of from 13-20 mm.

10. The method according to claim 7 wherein the pellets contain from 10 to 70 wt % of glass filaments based on the pellets.

11. The method according to claim 7 wherein the glass filaments have a thickness of from 5-50 μm.

12. The method according to claim 7 wherein the at least one continuous strand of glass filaments has a linear density of from 1000-5000 tex.

13. The pellets of claim 1, wherein
the pellets have a length of from 13-20 mm;
the pellets contain from 10 to 70 wt % of glass filaments based on the weight of the pellets; and
the glass filaments have a thickness of from 5-50 μm.

14. The pellets of claim 1, wherein
the pellets have a length of from 14-18 mm;
the pellets contain from 20 to 60 wt % of glass filaments based on the weight of the pellets; and
the glass filaments have a thickness of from 10-30 μm.

15. The pellets of claim 1, wherein
the pellets have a length of from 1 15-17 mm.
the pellets contain from 20 to 60 wt % of glass filaments based on the weight of the pellets and
the glass filaments have a thickness of from 15-25 μm.

16. The method of claim 7, wherein
the pellets have a length of from 13-20 mm;
the pellets contain from 10 to 70 wt % of glass filaments based on the weight of the pellets; and
the glass filaments have a thickness of from 5-50 μm.

17. The method of claim 7, wherein
the pellets have a length of from 14-18 mm;
the pellets contain from 20 to 60 wt % of glass filaments based on the weight of the pellets; and
the glass filaments have a thickness of from 10-30 μm.

18. The method of claim 7, wherein
the pellets have a length of from 1 15-17 mm.
the pellets contain from 20 to 60 wt % of glass filaments based on the weight of the pellets and
the glass filaments have a thickness of from 15-25 μm.
